(19) United States
(12) Patent Application Publication
(10) Pub. No.: US 2022/0405303 A1
(43) Pub. Date: Dec. 22, 2022

(54) DATA LAKE REPLICATIONS

(71) Applicant: Hewlett-Packard Development Company, L.P., Spring, TX (US)

(72) Inventors: Vijaya Pinjala, Spring, TX (US); Max Junior Cikoski, Spring, TX (US)

(73) Assignee: Hewlett-Packard Development Company, L.P., Spring, TX (US)

(21) Appl. No.: 17/772,160

(22) PCT Filed: Nov. 19, 2019
(86) PCT No.: PCT/US2019/062143

§ 371 Date: Apr. 27, 2022

(51) Int. Cl. G06F 16/27; G06F 16/28

(52) U.S. Cl. CPC G06F 16/27; G06F 16/283

(57) ABSTRACT

An example system may include a processor and a non-transitory machine-readable storage medium storing instructions executable by the processor to trigger, responsive to an event, a cloud function to replicate data from a source data lake to a destination data lake; obtain a permission, from an execution role for the cloud function, to execute the cloud function; and authenticate a role of the destination data lake to permit replication of the data from the source data lake to the destination data lake.

### BACKGROUND

A data lake may include a centralized data repository that may store unstructured data. For example, a data lake may store raw data in its native format until it is needed. Data stored in a data lake may be the subject of various types of analytics for various purposes. The data in a data lake may be useful to a plurality of users. As such, a plurality of users may want access to the data in the data lake. Data security and fidelity may influence the access granted to the users.

### BRIEF DESCRIPTION OF THE DRAWINGS

FIG. 1 illustrates an example of a system for data lake replications consistent with the present disclosure.

FIG. 2 illustrates an example of a computing device for data lake replications consistent with the present disclosure.

FIG. 3 illustrates an example of a non-transitory machine-readable memory and processor for data lake replications consistent with the present disclosure.

FIG. 4 illustrates an example of a method for data lake replications consistent with the present disclosure.

### DETAILED DESCRIPTION

Large amounts of raw data may be collected by, for example, device manufacturers and/or software developers. For example, logs from hundreds of thousands of device or software instances make be collected. The collected data may be stored in a data lake.

A data lake may include a data repository for storing unstructured data. For example, in contrast to a data warehouse which may include a relational database, a data lake may include a repository to hold large amounts of data in its raw and/or native form. The data in the data lake may be stored without a particular structure or schema defined when the data is captured.

The data in the data lake may be analyzed and/or utilized to systematically discover and/or extract information. For example, the data in the data lake may be analyzed to draw conclusions about the performance and/or improvement of devices and/or software serving as the source of the data. In other examples, the data in the data lake may be analyzed to draw conclusions about customers and what products to sell them.

The data in the data lake may be utilized by different users to discover and/or extract different information specific to their purpose. As such, different users may wish to access the same data and/or portions of data of the data lake.

A user may be granted access to the data lake to access the data. However, a portion of the data in the data lake may be data that should not be revealed to particular users. For example, a party that collected the data may not be permitted to expose personally identifiable information (PII) to a third party that is utilizing the data in the data lake for their purpose. Further, some users may make modifications to the data (e.g., add, change, delete, categorize, tag, transform, etc.) for the purpose of their analysis. Furthermore, some users may rely on the fidelity of the data being preserved. That is, some users may rely on the data not being changed by other users in order to preserve the validity of their respective analysis. As such, data lakes providing access to multiple users may expose sensitive information that should not be exposed to some users and may jeopardize the fidelity of the data in the data lake by exposing the data to modifications. Conversely, individual data from the data lake may be manually selected in a labor-intensive process to be manually copied to another memory resource.

In contrast, examples consistent with the present disclosure may include a system for replicating data across data lakes and/or data lake regions. By utilizing a cross-account role authentication to permit an automated object-level replication across multiple data lakes, examples consistent with the present system may provide a highly configurable and secure mechanism for controlled access to data in a data lake without jeopardizing the security and fidelity of the source data. For example, examples consistent with the present disclosure may include a system comprising a processor and a non-transitory machine-readable storage medium to store instructions executable by the processor to trigger, responsive to an event, a cloud function to replicate data from a source data lake to a destination data lake; obtain a permission, from an execution role for the cloud function, to execute the cloud function; and authenticate a role of the destination data lake to permit replication of the data from the source data lake to the destination data lake.

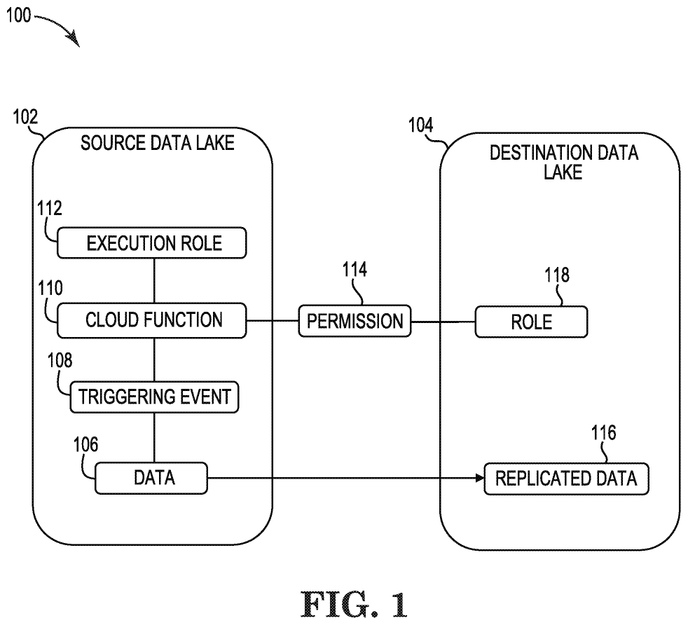

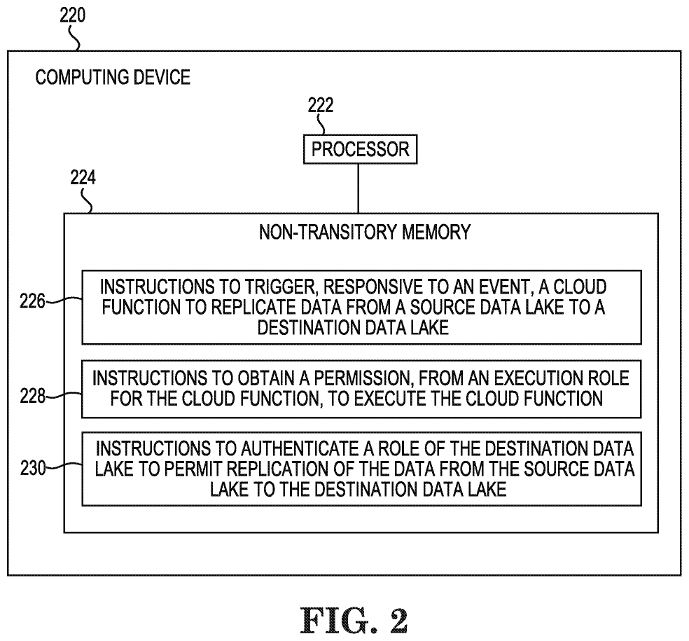

FIG. 1 illustrates an example of a system 100 for data lake replications consistent with the present disclosure. The described components and/or operations of the system 100 may include and/or be interchanged with the described components and/or operations described in relation to FIG. 2-FIG. 4.

The system 100 may include a source data lake 102. The source data lake 102 make include a data storage location. The source data 102 lake may, for example, include memory and/or computing resources, such as a cloud resource, to store data 106.

The source data lake 102 may include a data storage location for storing raw unstructured data 106. The source data lake 102 may act as a repository for large amounts of unstructured data 106 utilizable for various analytics operations. For example, the source data lake 102 may include data 106 collected by a manufacturer and/or a developer of a device or software application or operating system from instances of their product.

The source data lake 102 and the data 106 stored thereon may be managed. For example, data storage, data replication, data searching, data sharing, data analyzing, data handling governance, etc. may be managed for the source data lake 102. For example, a user may control or influence the control of the data 106 and/or its handling with respect to the source data lake 102 by adjusting settings for an account associated with the source data lake 102.

For example, the source data lake 102 may be associated with an account. An account may include a profile including a username or password associated with various permissions and/or settings. The account may be owned and/or controlled by a user. The user may be an individual user, a plurality of users, a business, etc. The user may log into the account and exercise permissions to adjust configurations, analyze the data 106, modify the data 106, modify the source data lake 102, etc.

Part of the management of the source data lake 102 may include the ability to manage data analysis and data replication for data 106 of the source data lake 102. For example, a user may adjust various settings of the account that control how data 106 is analyzed and replicated from the source data lake 102.

For example, a user may configure a cloud function 110 setting of the source data lake 102. For example, a cloud function 110 may be configured for a specific account, for the source data lake 102, and/or for specific objects of data 106 in the source data lake 102. A cloud function 110 may include a lambda function. As used herein, a lambda function may include instructions that may be assigned to variables, passed as an argument, and/or returned from a functional call in languages that support high-order functions. As such, a cloud function 110 may include instructions, executable at the source data lake 102 to perform operations on the data 106. For example, the cloud function 110 may include instructions defining a function regarding the analysis, modification, and/or replication of the data 106 in the source data lake 102. A cloud function 110 may also include configuration information such as the function name and resource requests associated with the cloud function 110.

The cloud function 110 may be associated with specific cloud resources. For example, the cloud function 110 may be associated with the source data lake 102 and/or portions of its data 106. Although, for simplicity of illustration, the cloud function 110 is illustrated within the source data lake 102, it should be understood that the cloud function 110 may be associated with the source data lake 102 and/or the account that is the owner of the source data lake 102 and not physically stored in the source data lake 102 with the unstructured data 106.

Additionally, a triggering event 108 may be configured. For example, a triggering event may be configured for a specific cloud function 110 of a specific account and/or a specific data lake. The triggering event 108 may include an event that may invoke the cloud function 110.

For example, a triggering event 108 may include a change in a cloud resource. For example, a triggering event 108 may include a change in the state of the source data lake 102 and/or the data 106 in the source data lake 102. For example, an event may be generated and/or detected when data 106 is modified in the source data lake 102 and/or when data 106 is ingested into the source data lake 102. Ingesting data 106 to the source data lake 102 may include the process of flowing data from its origin (e.g., a user device, a telemetry log, a software instance, a source cloud etc.) to one or more data sores such as the source data lake 102. For example, the data 106 may be ingested as a user upload, a telemetry ingestion, and/or a cloud-to-cloud ingestion into the source data lake 102.

An event may be a triggering event 108 with respect to the cloud function 110 when a rule maps a detected triggering event 108 to invocation of a corresponding cloud function 110. For example, a rule may map an event such as a modification of data 106 in the source data lake 102 and/or its ingestion into the source data lake 102 to the invocation of a cloud function 110 applicable to replicate the modified and/or ingested data 106. In such examples, the modification and/or ingestion of data 106 may be a triggering event 108 that triggers the invocation of the cloud function 110 which may be applied to the modified and/or ingested data 106.

The system 100 may include an execution role 112. The execution role 112 may include a role name, permissions associated with the role, and/or a trusted entity. The execution role 112 may include a permissions policy that may be assumed by the cloud function 110. For example, the execution role 112 may include permissions, to access various services and/or cloud resources, that may be granted to the cloud function 110 when the cloud function assumes the execution role.

The execution role 112 may be configurable by a user. For example, the execution role 112 may be configured by modifying the permissions of the execution role 112. The execution role may be configured for a specific cloud function 110, a specific triggering event 108, a specific account managing a source data lake 102, a specific cloud region, etc.

The cloud function 110 may assume the execution role 112 when it is invoked. For example, then the cloud function 110 is invoked the corresponding execution role 112 may be authenticated to the cloud function 110. With a successful authentication, the cloud function 110 may be invoked according to and/or in observance of the permissions defined in the corresponding authenticated execution role 112. If the execution role 112 for the cloud function 110 does not permit the invocation of the cloud function 110 in the context invoked by the triggering event 108, then the cloud function 110 will not be executed. For example, if the execution role 112 is not authenticated to the cloud function 110, then the cloud function 110 may not be invoked.

The data 106 stored in the source data lake 102 may be replicated. For example, the data 106 in the source data lake 102 may be replicated to a destination data lake 104. The destination data lake 104 may include a data lake that is separate from the source data lake 102.

In some examples, the source data lake 102 may be associated with and/or managed by a first account. For example, the source data lake 102 may be associated with and/or managed by an account of a device manufacturer and/or software developer. The destination data lake 104 may be associated with a second account. The second account may be a separate account from the first account. For example, the destination data lake may be associated with a different entity such as an e-commerce company. As such, data 106 may be replicated from a source data lake 102 associated with a first account to a destination data lake 104 associated with a different account.

In some examples, the source data lake 102 and the destination data lake 104 may be associated with the same account. However, the source data lake 102 may be associated with a first region of the account and the destination data lake 104 may be associated with a second region of the same account. For example, the source data lake 102 may be associated with a first business unit, such as a software development unit, of a device manufacturer and/or software developer that owns the account. The destination data lake 104 may be associated with a second business unit, such as a marketing unit, of the device manufacturer and/or software developer that owns the account. As such, data 106 may be replicated from a source data lake 102 associated with a first region of an account to a destination data lake 104 associated with a second region of the same account.

Replicating data 106 between the source data lake 102 and the destination data lake 104 may be triggered by a triggering event 108. For example, the triggering event 108 may include an ingestion of data 106 into the source data lake 102. The ingestion of data 106 may include the process of flowing data from its origin (e.g., a user device, user log, etc.) to one or more data stores such as the source data lake 102. For example, the data 106 may be ingested as a user upload, a telemetry ingestion, and/or a cloud-to-cloud ingestion. In some examples, the triggering event 108 may include a modification (addition, deletion, change, etc.) to the data 106 in the source data lake 102.

In response to detecting the triggering event 108 a cloud function 110 may be invoked. For example, a cloud function 110 that is mapped to the triggering event 108 may be invoked. In some examples, the cloud function may include a function executable to replicate data 106 from the source data lake 102 to the destination data lake 104.

However, prior to and/or as a precondition to executing the cloud function 110, a permission to execute the cloud function 110 may be obtained from the execution role 112 for the cloud function 110. For example, the execution role 112 may specify permission policies associated with executing the cloud function 110 triggered by the triggering event 108. For example, the execution role 112 may specify under which circumstances the cloud function 110 may be executed. For example, the execution role 112 may be assumed by the cloud function 110 in order to grant permissions to the cloud function 110 to access various resources and/or to perform various operations such as replicating the data 106. If the execution role 112 authorizes the cloud function 110 execution, then the cloud function 110 may assume the execution role 112 in order to obtain permissions to execute the cloud function 110. If the execution role 112 does not authorize the cloud function execution, then the cloud function 110 may not execute.

The cloud function 110 may have assumed the permissions authorized by the execution role 112, but the assumed permissions may be limited to the source data lake 102 side of the data replication operation. That is, the cloud function 110 may have the permissions to access the data 106 and perform various operations associated with its replication, but the cloud function 110 may still lack permission 114 with respect to replicating the data 106 to the destination data lake 104. That is, in order to execute the cloud function 110 and replicate the data 106 to the destination data lake 104, the cloud function 110 may have to obtain permission to write the data 106 to a destination data lake 104.

The cloud function 110 may include a configuration specifying which role 118 of the destination data lake 104 will be utilized to replicate the data 106. The role 118 of the destination data lake 104 may include an identity and access management (IAM) role. The role 118 may include an IAM identity that may be created in an account and that may specify permission policies (e.g., what the role is allowed and not allowed to do) associated with the role 118. The role 118 may be associated with the destination data lake 104 but may be assumed by the source data lake 102 and/or the cloud function 110. For example, the role 118 may not include standard long-term credentials such as a password or an access key associated with it. Instead the role 118 may be assumed by the source data lake 102 and/or the cloud function 110 to provide the source data lake 102 and/or the cloud function 110 with the temporary security credentials to provide permission 114 for a role session including executing the cloud function 110 to replicate the data 106.

As described above, the destination data lake 104 may include a destination lake associated with a different account than and/or a different region of the same account as the source data lake. As such, the cloud function 110 may have to assume a cross-account and/or a cross-region role 118 in order to achieve the cross-account and/or cross-region permission 114 to execute the cloud function 110 to replicate the data 106 to the destination data lake 104. As such, a call to a role 118 associated with the destination data lake 104 may be placed from an account or region associated with the source data lake 102. The role 118 associated with the destination data lake 104 may be authenticated with respect to the cloud function 110 at the source data lake 102.

If the authentication of the role 118 with respect to the cloud function 110 is not authenticated (e.g., the role 118 rejects the call) then the role 118 may not be assumed by the cloud function 110. As such, the data 106 may not be replicated from the source data lake 102 to the destination data lake 104.

However, if the authentication is successful, then the cloud function 110 may assume the role 118 associated with the source data lake 102. As a result, the cloud function 110 may possess the permissions (e.g., via assumption of the execution role 112 and via assumption of the role 118 associated with the destination data lake 104) to replicate the data 106 from the source data lake 102 to the destination data lake 104.

Execution of the cloud function 110 may result in the generation of an event payload. An event payload may include a source data lake path. The source data lake path may include a portion of the path to be utilized to replicate the data 106 from the source data lake 102 to the destination data lake 104. For example, the source data lake path may include the instructions for performing a portion of the data processing operation of replicating the data 106 from the source data lake 102 to the destination data lake 104. For example, the source data lake path may include a path to identify and/or retrieve the data 106 from the source data lake 102 for replication to the destination data lake 104.

A destination data lake path may be retrieved from configuration information associated with the cloud function 110. For example, the configuration of the cloud function 110 and/or the configuration of the execution role 112 and/or cross-account/cross-region role 118 assumed by the cloud function may specify the destination data lake path. The destination data lake path may include a portion of the path to be utilized to replicate the data 106 from the source data lake 102 to the destination data lake 104. For example, the destination data lake path may include the instructions for performing a portion of the data processing operation of replicating the data 106 from the source data lake 102 to the destination data lake 104. For example, the destination data lake path may include a path to identify and/or locate where the replicated data 116 will be replicated to within the destination data lake 104.

The event payload may also include a portion of the data 106. That is, the data 106 may be replicated at an object level where the object may be less than all of the data 106. For example, the event payload may include an object of a plurality of data objects in the source data lake 102. That is, the event payload may include all of or less than all of the data 106 that was ingested or modified in the triggering event 108 and/or all of or less than all of the data present in the source data lake 102.

In some examples, the event payload may include modified data 106. For example, executing the cloud function 110 may include modifying the portion of the data 106 from the source data lake 102 prior to replicating the portion of the data 106 to the destination data lake 104. For example, executing the cloud function 110 may include modifying the data 106 by removing a portion of the data 106 such as personally identifying information and/or information not germane to the analysis to be performed at the destination data lake 104.

The modification to be performed to the data 106 may be defined in the configuration of the execution role 112 and/or the cloud function 110. For example, a predefined business rule may be part of the configuration of the execution role 112 and/or the cloud function 110. The predefined business rule may define information that is germane to the analysis to be conducted on the replicated data 116 at the destination data lake 104 and/or information to be modified as part of the execution of the cloud function 110. The business rules may be configurable and/or able to be modified by a user.

The modified data 106 in the event payload resulting from the execution of the cloud function 110 may be the replicated data 116. The replicated data 116 may include the portion and/or modified portion of the data 106 to be delivered to the destination data lake 104.

The replicated data 116 may be replicated to the destination data lake 104. For example, the replicated data 116 may include a data object replicated from the source data lake 102 to the destination data lake 104 via execution of the cloud function 110. The replicated data 116 may be saved in the destination data lake 104. The replicated data 116 may be saved in a raw or native format into the destination data lake.

The replicated data 116 may be an object-level replication of the data 106 from the source data lake 102. An object-level replication may include a replication of just those data objects (e.g., folders, files, data entries, telemetry logs, etc.) that are modified, ingested, and/or permitted to be replicated. That is, an object-level replication may include replication of a data object of a plurality of data objects at the source data lake 102.

The replicated data 116 may be fully controlled at the destination data lake 104 (e.g., by the account associated with the destination data lake 104, by the region associated with the destination data lake 104, etc.). For example, the replicated data 116 may be modified (e.g., added to, changed, deleted, categorized, tagged, transformed, etc.) without limitations. For example, modifying the replicated data 116 stored in the destination data lake 104 may not affect and/or alter the source data 106 in the source data lake 102. In this manner, the fidelity of the data 106 in the source data lake 102 may be preserved while allowing managers of the destination data lake 104 the freedom to operate on the replicated data 116 as they see fit. Further, since data masking and/or filtering may be performed on the data 106 of the source data lake 102 by execution of the cloud function 110 to produce the replicated data 116, the manager of the destination data lake 104 may not have access to sensitive data (e.g., data designated to be masked or filtered) but the sensitive data may be retained unmodified in the data 106 stored in the source data lake 102. Furthermore, since the manager of the destination data lake 104 does not have direct access to the source data lake 102, but merely the replicated data 116 therefrom, security risks associated with direct access and security mechanisms to ameliorate those risks may be reduced. Moreover, the system 100 may provide for data 106 replication to multiple destination lakes 104, which may be associated with multiple accounts and/or multiple regions of the same account, in the manner described above.

FIG. 2 illustrates an example of a computing device 220 for data lake replications consistent with the present disclosure. The described components and/or operations described with respect to the computing device 220 may include and/or be interchanged with the described components and/or operations described in relation to FIG. 1 and FIG. 3-FIG. 4.

The computing device 220 may include a desktop computer, a notebook computer, a tablet computer, a thin client, a smartphone, a smart device, a wearable computing device, a smart consumer electronic device, a server, a virtual machine, across a distributed computing platform, etc. The computing device 220 may include a processor 222 and a non-transitory memory 224. The non-transitory memory 224 may include a non-transitory machine-readable storage medium to store instructions (e.g., 226, 228, 230, etc.) that when executed by the processor 222, cause the computing device 220 to perform various operations described herein. While the computing device 220 is illustrated as a single component, it is contemplated that the computing device 220 may be distributed among and/or inclusive of a plurality of such components.

The computing device 220 may execute the instructions 226 to trigger a cloud function. The cloud function may be triggered in response to an event. The event may include the ingestion of data in a source data lake. Additionally, the event may include the modification of data in the source data lake.

The cloud function may include a lambda function. For example, the cloud function may include a lambda function to replicate the data from the source data lake to the destination data lake. The source data lake may be associated with a first cloud account. That is, the source data lake may be managed under a first account. The destination data lake may be associated with a second account. That is, the destination data lake may be managed under a second account that is separate from and/or has different ownership from the first account. Alternatively, the source data lake may be associated with a first region of a cloud account and the destination data lake may be associated with a second region of the same cloud account but that is distinctly controlled from the first region. For example, the source data lake and the destination data lake may be managed by different identities or profiles under the ownership umbrella of the same account.

The computing device 220 may execute instructions 228 to obtain a permission to execute the cloud function. The permission to execute the cloud function may be obtained from an execution role associated with the triggering event and/or the cloud function. If the execution role is successfully authenticated to the cloud function, then the cloud function may assume the execution role including its permissions. As such, the cloud function may assume the permissions to execute the cloud function. However, since the data replication as issue is one between data lakes and may involve a cross-account and/or a cross-region data replication, permission to replicate the data across accounts or regions may additionally be sought.

The computing device 220 may execute instructions 228 to authenticate a role associated with the destination data lake. That is, in order to execute the cloud function, the cloud function may have to assume a role of the destination data lake and its permissions. For example, if the role of the destination data lake successfully authenticates to the cloud function, then the cloud function may assume the permissions associated with the role of the destination data lake. The role of the destination data lake may provide the cross-account and/or cross-region permissions to permit the replication of the data from the source data lake to the destination data lake.

Once the source data lake and destination data lake roles have authenticated to the cloud function, the cloud function may be executed to replicate the data from the source data lake to the destination data lake. The execution of the cloud function may generate an event payload. The event payload may include the portion of the data to be replicated to the destination data lake. The event payload may include a source data lake path specifying the data path to the source data in the source data lake to be replicated. The source data lake path may be retrieved from the event payload to replicate the data. The destination data lake path specifying the data path to the destination where the data is to be replicated may be retrieved from the configuration information associated with the cloud function to replicate the data.

The replication may be an object level replication and the data objects may be processed by masking, filtering, and/or otherwise modifying according to predefined rules associated with and/or assumed by the cloud function. Once the data is replicated to the source data lake, the replicated data may be modified without affecting the source data in the source data lake.

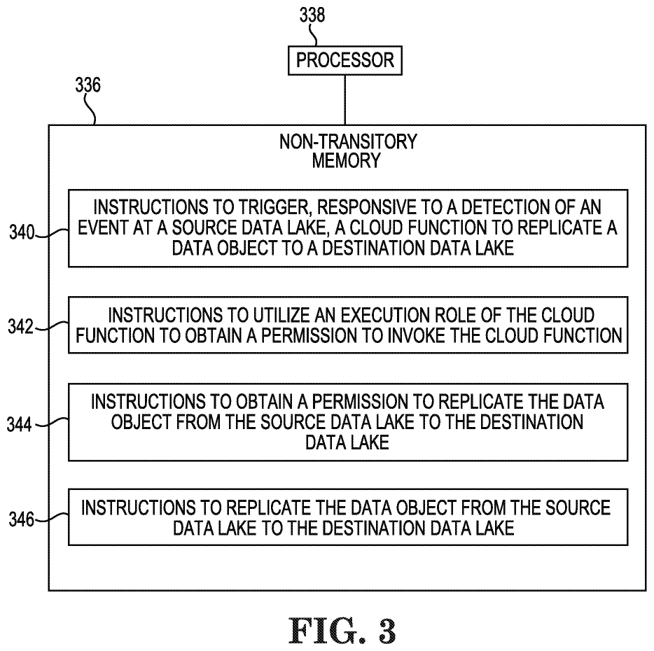

FIG. 3 illustrates an example of a non-transitory machine-readable memory and processor for data lake replications consistent with the present disclosure. A memory resource, such as the non-transitory machine-readable memory 336, may be utilized to store instructions (e.g., 340, 342, 344, 346, etc.). The instructions may be executed by the processor 338 to perform the operations as described herein. The operations are not limited to a particular example described herein and may include and/or be interchanged with the described components and/or operations described in relation to FIG. 1-FIG. 2 and FIG. 4.

The non-transitory machine-readable memory 336 may store instructions 340 executable by the processor 338 to trigger a cloud function. The cloud function may be triggered responsive to detecting a triggering event at a source data lake. The cloud function may include a lambda function executable to replicate a data object to a destination data lake.

The source data lake may include a plurality of data objects. The data object to be replicated may be one of the plurality of data objects. As such, the replication of data from the source data lake to the destination data lake may be an object-level replication. The data object to be replicated may be identified for replication from among the plurality of data objects at the source data lake by a configuration of the cloud function being triggered by the triggering event. For example, the cloud function may include instructions identifying a particular data object or class of data objects to be utilized in a data replication operation.

The non-transitory machine-readable memory 336 may store instructions 342 executable by the processor 338 to utilize an execution role of the cloud function to obtain a permission to invoke the cloud function. For example, an execution role associated with the cloud function may provide permission to invoke the cloud function. As such, the execution role may be authenticated to the cloud function and its permissions may be assumed by the cloud function.

The non-transitory machine-readable memory 336 may store instructions 344 executable by the processor 338 to obtain a permission to replicate the data object from the source data lake to the destination data lake. The permission to replicate the data object from the source data lake to the destination data lake may include a permission in addition to the permission to invoke the cloud function.

For example, the source data lake may include a data lake managed under a first account and/or managed under a first region of a first account. The destination data lake may include a data lake managed under a second account or managed under a second region of the first account. As such, the permission to invoke the cloud function may include a permission associated with and/or granted from the first account and/or the first region. The permission to replicate the data object from the source data lake to the destination data lake may, however, include a cross-account and/or a cross-region permission associated with and/or granted by the second account or the second region.

The permission to replicate the data object form the source data lake to the destination data lake may, therefore, be obtained from a separate account or region and involve an authentication operation across accounts and/or regions in a same account. For example, the permission to replicate the data object may be obtained based on an authentication operation between the source data lake and the destination data lake. That is, a role associated with the account and/or region of the destination data lake and/or associated with the destination data lake itself may be authenticated to the cloud function. A successful authentication may result in the source data lake assuming the authenticated role of the destination data lake and its permissions regarding replicating a data object from the source data lake to the destination data lake.

The non-transitory machine-readable memory 336 may store instructions 346 executable by the processor 338 to execute the cloud function to replicate the data object from the source data lake to the destination data lake. Replicating the data object may include processing the data to create a replicated data object. For example, while the source data object may remain unmodified, the replicated data object may be a modified version of the source data object that is modified according to business rules specified by a modifiable configuration of the cloud function. Once the replicated data object is stored in the destination data lake, the replicated data object may be modified at the destination data lake without modifying the data object stored in the source data lake. Conversely, a modification to the data object in the source data lake may trigger the invocation and execution of the cloud function in the manner described above to correspondingly modify the replicated data object stored in the destination data lake.

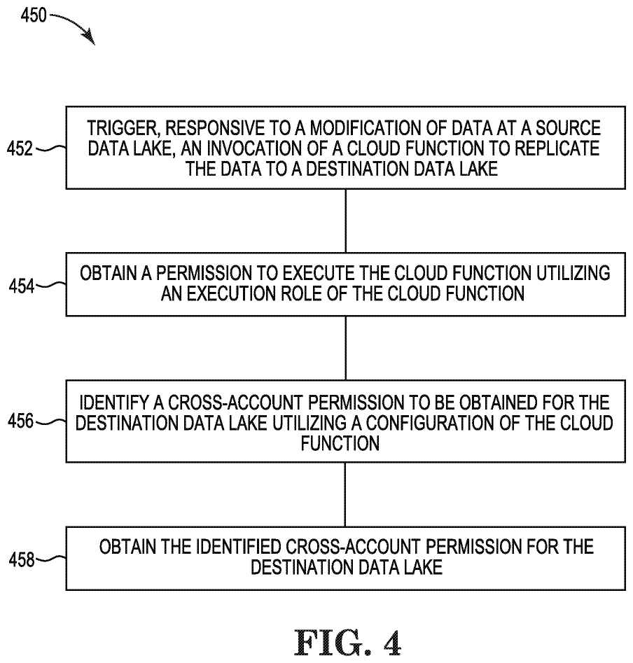

FIG. 4 illustrates an example of a method 450 for data lake replications consistent with the present disclosure. The described components and/or operations of method 450 may include and/or be interchanged with the described components and/or operations described in relation to FIG. 1-FIG. 3.

At 452, the method 450 may include triggering an invocation of a cloud function. The cloud function may be invoked to replicate data from a source data lake to a destination data lake. The invocation of the cloud function may be triggered responsive to a modification of data at a source data lake. A modification of data at a source data lake may include an addition, an ingestion, a change, a deletion, a categorization, a tagging, a transformation, etc. of data stored in a source data lake.

At 454, the method 450 may include obtaining a permission to execute the cloud function. The permission may be obtained utilizing an execution role of the cloud function. The execution role may be authenticated to the cloud function and its permissions may be assumed by the cloud function. As such, the cloud function may obtain the permission to execute, in part, by assumption of the execution role permissions.

At 456, the method 450 may include identifying a cross-account permission to be obtained for the destination data lake. For example, a configuration of the cloud function may identify a destination data lake path. That is, the cloud function may include a configuration specifying where the data from the source data lake will be replicated to. In order to execute the cloud function and replicate the data accordingly, the cloud function may also obtain a permission from the destination data lake.

The source data lake and the destination data lake may be managed by different accounts. As such, in order to execute the cloud function to replicate data from the source data lake managed by a first account to a destination data lake managed by a second account, the cloud function may utilize both a permission from the first account associated with source data lake account (e.g., from the lambda execution role of the cloud function) and from the second account associated with the destination data lake (e.g., an IAM role associated with the destination data lake). Therefore, obtaining both permissions may include identifying the cross-account permission (e.g., an IAM role associated with the destination data lake) to be obtained from the destination data lake. The configuration of the cloud function may identify the cross-account permission to be obtained in its identification of the destination data lake path.

At 458, the method 450 may include obtaining the identified cross-account permission for the destination data lake. For example, a cross-account call to a cross-account role associated with the destination data lake may be placed from an account or region associated with the source data lake 102. The cross-account role associated with the destination data lake 104 may be authenticated with respect to the cloud function at the source data lake. If the authentication of the cross-account role with respect to the cloud function is not authenticated (e.g., the cross-account role rejects the call) then the cross-account role may not be assumed by the cloud function. As such, the data may not be replicated from the source data lake to the destination data lake. If, however, the authentication of the cross-account role with respect to the cloud function is successfully authenticated (e.g., the cross-account role accepts the call) then the cross-account role may be assumed by the cloud function along with its cross-account data replication permissions.

Additionally, the method 450 may include modifying the data, at the source data lake, to obscure personally identifiable information. The modified data may become part of the replicated data to be moved to the destination data lake. That is, the modified data may be replicated to the destination data lake while the source data, remaining stored at the source data lake remains unmodified.

As described above, data replication may be performed across a plurality of destination data lakes. In some examples, the method 450 may include replicating a first portion of the data to the destination data lake based on the configuration of the cloud function and replicating a second portion of the data to a second destination data lake based on the configuration of the cloud function. That is, the configuration of the cloud function, including the operations defined by execution of the cloud function, may specify different portions of data and/or different data objects to be replicated to the first destination data lake and the second destination data lake. Additionally, the configuration of the cloud functions may specify a first modification to be performed to data to be replicated to the first destination data lake versus and a second modification, different from the first modification, to be performed to data to be replicated to the second destination data lake. As such, data being replicated from the source data lake may undergo distinct processing based on the destination data lake that it will be replicated to.

Regardless of the destination data lake that the replicated data to replicated to, the handling of the replicated data at its destination data lake may not affect the corresponding source data in the source data lake. For example, a modification to the replicated data in the destination data lake may not be carried over of affect the corresponding source data in the source data lake.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure. Further, as used herein, “a plurality of” an element and/or feature can refer to more than one of such elements and/or features.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the disclosure. In addition, the proportion and the relative scale of the elements provided in the figures are intended to illustrate the examples of the disclosure and should not be taken in a limiting sense.

What is claimed:

1. A system, comprising:
a processor; and
a non-transitory machine-readable storage medium to store instructions executable by the processor to:
trigger, responsive to an event, a cloud function to replicate data from a source data lake to a destination data lake;
obtain a permission, from an execution role for the cloud function, to execute the cloud function; and
authenticate a role of the destination data lake to permit replication of the data from the source data lake to the destination data lake.

2. The system of claim 1, wherein the event includes the ingestion of the data into the source data lake.

3. The system of claim 1, wherein the event includes the modification of the data in the source data lake.

4. The system of claim 1, including instructions executable by the processor to retrieve a source data lake path from an event payload generated by an execution of the cloud function.

5. The system of claim 1, including instructions executable by the processor to retrieve a destination data lake path from configuration information associated with the cloud function.

6. The system of claim 1, wherein the source data lake is associated with a first cloud account and the destination data lake is associated with a second cloud account.

7. The system of claim 1, wherein the source data lake is associated with a first region of a cloud account and the destination data lake is associated with a second region of the cloud account.

8. A non-transitory machine-readable storage medium comprising instructions executable by a processor to:
trigger, responsive to a detection of an event at a source data lake, a cloud function to replicate a data object to a destination data lake;
utilize an execution role of the cloud function to obtain a permission to invoke the cloud function;
obtain a permission to replicate the data object from the source data lake to the destination data lake; and
replicate the data object from the source data lake to the destination data lake.

9. The non-transitory machine-readable storage medium of claim 8, wherein the permission to replicate the data object is obtained based on an authentication operation between the source data lake and the destination data lake.

10. The non-transitory machine-readable storage medium of claim 8, wherein the data object is identified from a plurality of data objects at the source data lake for replication by a configuration of the cloud function.

11. The non-transitory machine-readable storage medium of claim 8, wherein a modification to the replicated data object at the destination data lake does not modify the data object at the source data lake.

12. A method, comprising:
triggering, responsive to a modification of data at a source data lake, an invocation of a cloud function to replicate the data to a destination data lake;
obtaining a permission to execute the cloud function utilizing an execution role of the cloud function;
identifying a cross-account permission to be obtained for the destination data lake utilizing a configuration of the cloud function; and
obtaining the identified cross-account permission for the destination data lake.

13. The method of claim 12, comprising modifying the data, at the source data lake, to obscure personally identifiable information.

14. The method of claim 13, comprising replicating the modified data to the destination data lake.

15. The method of claim 13, comprising:
replicating a first portion of the data to the destination data lake based on the configuration of the cloud function; and
replicating a second portion of the data to a second destination data lake based on the configuration of the cloud function.
